(19) United States
(12) Patent Application Publication
(10) Pub. No.: US 2006/0192899 A1
(43) Pub. Date: Aug. 31, 2006

(54) Projection type video reproducing apparatus

(75) Inventor: Minoru Ogita, Hamamatsu-shi (JP)

Correspondence Address: MORRISON & FOERSTER, LLP, 555 WEST FIFTH STREET, SUITE 3500, LOS ANGELES, CA, 90013-1024, US

(73) Assignee: Yamaha Corporation, Hamamatsu-Shi (JP)

(21) Appl. No.: 11/364,761

(22) Filed: Feb. 27, 2006

(30) Foreign Application Priority Data
Feb. 28, 2005 (JP) 2005-054635
Jun. 27, 2005 (JP) 2005-186373

(51) Int. Cl. H04N 9/31

(52) U.S. Cl. 348/744

(57) ABSTRACT

A projection type video reproducing apparatus includes a video display element that visualizes a video signal, a video display element drive circuit that drives the video display element, a high-speed response light source that applies projection light onto the video display element, a light source drive circuit that turns the light source on, and a video signal conversion portion. The video signal conversion portion executes: a peak detection process for detecting peak values of luminance of the video signal at intervals of a unit time; a conversion coefficient calculation process for calculating a conversion coefficient based on a ratio of each detected peak value to an upper limit of the luminance or based on a difference between each detected peak value and an upper limit of the luminance; a video signal conversion process for converting the luminance value of the video signal in the unit time based on the conversion coefficient so as to increase the luminance value and supplying the luminance value to the video display element drive circuit; and a light intensity control process for setting a control value based on the conversion coefficient to reduce the light intensity of the light source and controlling the light source drive circuit in accordance with the control value.

### BACKGROUND OF THE INVENTION

The present invention relates to a projection type video reproducing apparatus for enlarging and projecting video on a screen.

A projector is known as an apparatus for enlarging and reproducing video. The projector is an apparatus provided with an optical system through which video is projected on a screen set up on a wall surface. A back type apparatus has been also put into practice. That is, the back type apparatus is provided with a housing having a front surface on which a screen is provided so that video is projected on the screen from a back surface of the inside of the housing.

A light source such as a mercury lamp or a halogen lamp has been heretofore used in such a projection type video reproducing apparatus because of necessity of strong projection light (e.g. JP-A-2004-264668).

The light source such as a mercury lamp or a halogen lamp, however, has the following drawbacks. That is, the light source has to be preheated because light emission just after turning-on of the light source is unstable. A heat radiation fan has to be used because the light source generates a large amount of heat (self-generated heat and radiant heat). Driving noise of the fan causes trouble during video reproduction. Even after the light source is turned off, the fan cannot be stopped soon because the light source has to be cooled after use.

It is therefore conceived that high-luminance LEDs are used as a light source. That is, the LEDs are preferably used as a light source for a projection type video reproducing apparatus compared with the mercury lamp or the halogen lamp because the LEDs have good response, the LEDs can be used soon after turning-on, and light emitted from the LEDs has a pure spectrum without radiant heat.

It is however necessary to use hundreds or thousands of LEDs in a bundle because one LED has no light intensity more than several lumens even in the case where the LED is a high-luminance LED. There is a problem that efficiency is lowered at the stage where light emitted from the LEDs is condensed.

### SUMMARY OF THE INVENTION

An object of the invention is to provide a projection type video reproducing apparatus using high-speed response of LEDs for achieving power saving.

(1) The invention provides a projection type video reproducing apparatus including: a video display element for visualizing a video signal; a video display element drive circuit for driving the video display element; a high-speed response light source for applying projection light onto the video display element; a light source drive circuit for turning the light source on; and a video signal conversion portion which executes: a peak detection process for detecting peak values of luminance of the video signal at intervals of a unit time; a conversion coefficient calculation process for calculating a conversion coefficient based on a ratio of each detected peak value to an upper limit of the luminance or based on a difference between each detected peak value and an upper limit of the luminance; a video signal conversion process for converting the luminance value of the video signal in the unit time based on the conversion coefficient to increase the luminance value and supplying the luminance value to the video display element drive circuit; and a light intensity control process for setting a control value based on the conversion coefficient to reduce the light intensity of the light source and controlling the light source drive circuit in accordance with the control value.

A subject of the invention is a projection type video reproducing apparatus in which high-speed response devices such as high-luminance LEDs are used as a light source for applying projection light onto a video display element. In a general projection type video reproducing apparatus (projector), the light source always emits light with predetermined light intensity. In the invention, high-speed response characteristic of the light source is used so that video in a dark scene is converted into bright video while the light source is darkened in accordance with the video conversion. As a result, the same video as in the case of direct reproduction of a dark video signal can be displayed, so that power saving can be attained on the basis of darkening of the light source.

For example, the unit time is a video frame or horizontal scanning period. The highest luminance value in the video signal in this period is set as a peak value. The conversion coefficient is decided so that the peak value is equal to a limit value. The luminance value of the video signal is converted on the basis of the conversion coefficient. The conversion coefficient is the maximum conversion coefficient in the unit time. In this manner, the width of conversion of the video signal can be maximized, so that the light intensity of the light source can be minimized accordingly.

Incidentally, in the case of monochrome video, this process may be performed on the luminance signal once per unit time. In the case of color video, this process is repeated concurrently or successively by the number of colors per unit time. For example, in the case of the three primary colors of R, G and B, this process is executed once each color, that is, this process is executed three times in one unit time. In this case, the luminance value in the invention is a component value of each of R, G and B color component signals.

(2) In the invention, when the conversion coefficient calculated by the conversion coefficient calculation process is smaller than a predetermined threshold, the video signal conversion portion sets the threshold as the conversion coefficient instead and executes the video signal conversion process and the light intensity control process.

When the conversion coefficient is large, conversion is performed to increase the luminance value of the video signal and the light intensity of the light source. That is, conversion is performed so that the video signal becomes very bright while the light intensity of the light source becomes very low (dark). For example, in the light source such as LEDs, there is however the lowest voltage/current necessary for operating the light source stably. If the current/voltage is lower than the lowest value, the light source cannot be turned on stably. In the invention, therefore, a threshold for the conversion coefficient is set so that conversion is not performed till the region where the current/voltage to make the operation unstable is applied. Even in the case where the conversion coefficient is larger than the threshold, conversion is performed with the threshold as a limit. In this manner, conversion can be performed in the range where the light source operates stably even in the case where conversion is performed to reduce the light intensity of the light source.

(3) In the invention, in the conversion coefficient calculation process, a conversion coefficient is calculated based on ratios or differences calculated when processing is made for a present unit time and at least one past unit time.

In the invention, the light intensity of the light source is controlled while the luminance value of the video signal is converted in each unit time. If the luminance value of the video signal and the light intensity of the light source change widely in accordance with the unit time, there is a possibility that the screen will flicker because of quantization error, linearity error, etc. Therefore, the present value and the past value are averaged to relax extreme change to thereby prevent the screen from flickering.

(4) In the invention, in the conversion coefficient calculation process, a conversion coefficient is calculated by taking a weighted average of ratios or differences calculated when processing is made for a present unit time and at least one past unit time, so that weighting for the ratio of the present unit time in the weighted average is increased when the ratio of the present unit time is larger than the ratio of the preceding unit time, or weighting for the difference of the present unit time in the weighted average is increased when the difference of the present unit time is smaller than the difference of the preceding unit time.

In the invention, when the screen is brightened, weighting for the value in the present unit time is increased to improve tracking characteristic with respect to the value in the present unit time. In this manner, reproducibility in a video method (shift of scene or impactful video effect) for changing video from a dark scene to a bright scene can be improved.

(5) In the invention, the video signal conversion portion executes the respective processes digitally so that only the most significant bit of the conversion coefficient is calculated as a binary digit “1” in the conversion coefficient calculation process and the luminance value of each pixel of the video signal is bit-shifted by the number of digits “0” in the conversion coefficient so as to be increased in the video signal conversion process.

When a process such as conversion of a video signal is performed digitally, the video signal can be expressed in binary data corresponding to pixels. Because a huge arithmetic operation is required for a process of converting luminance values of all pixels in a unit time, the load imposed on a processing portion is large. Therefore, the conversion coefficient is expressed in a binary number, for example, “10000” (=16) with the most significant bit expressed in a binary digit “1”. Each luminance value is multiplied by the conversion coefficient to thereby convert the luminance value of the video signal. Because the multiplication by the coefficient with the most significant bit “1” can be achieved by bit shift simply, the process is so easy that the load imposed on the processing portion can be lightened.

(6) In the invention, the video display element drive circuit visualizes the video signal by driving the video display element at a time rate corresponding to the luminance value of the video signal; and the light source drive circuit controls the light intensity of the light source by controlling the value of current supplied to the light source.

In the invention, when a device expressing luminance in on-time width of PWM such as a digital mirror device is used as the video display element, the video display element drive circuit controls luminance of each pixel in a PWM control manner. In accordance with the luminance control, the light source drive circuit controls light intensity by controlling the value of current so that the light source emits light with the controlled light intensity constantly in the unit time. In this manner, when PWM control is used on one hand, static control is used on the other hand so that the two kinds of control can work synergistically effectively.

(7) In the invention, the video display element drive circuit visualizes the video signal by driving the video display element to obtain transmittance or reflectance corresponding to the luminance value of the video signal; and the light source drive circuit controls the light intensity of the light source by controlling a time rate at which a current is supplied to the light source.

In the invention, when an analog/static device such as an LCD is used as the video display element, the video display element drive circuit controls luminance of each pixel on the basis of a voltage supplied to the video display element so that the luminance can be controlled statically in the period of display of the pixel. The light source drive circuit controls the light intensity of the light source on the basis of the time rate due to PWM, etc. When the light intensity of the light source is controlled on the basis of the time rate, linearity (direct proportion of operating quantity (light intensity control data) to controlled quantity (actual light intensity)) can be made accurate.

(8) In the invention, the video signal conversion portion stores a table (relation data) indicating the relation between the value of current supplied to the light source and the intensity of light; and in the light intensity control process, the light intensity of the light source is decided on the basis of the conversion coefficient, the value of current is decided by searching the table on the basis of the decided light intensity and the decided value of current is indicated to the light source drive circuit.

When the light intensity of a light source element such as an LED is controlled on the basis of the value of current, displacement occurs because the light output is not direct proportional to the control signal as shown in FIG. 4B. To compensate for the displacement, the value of current supplied to the light source is decided on the basis of the table to thereby keep the linearity.

(9) The invention provides a projection type video reproducing apparatus including: a video display element for visualizing a video signal; a video display element drive circuit for driving the video display element; a high-speed response light source for applying projection light onto the video display element; a light source drive circuit for turning the light source on and controlling light intensity of the light source by controlling a value of current supplied to the light source; a table storage portion (data storage portion) for storing a table indicating the relation between the value of current supplied to the light source and the intensity of light; a light intensity sensor provided near the light source; and a video signal conversion portion which executes: a table generating process (data generating process) for instructing the light source drive circuit to change the current supplied to the light source from a minimum to a maximum, measuring the light intensity of the light source at each value of current by using the light intensity sensor, generating the table on the basis of a result of the measurement and storing the table in the table storage portion; a peak detection process for detecting peak values of luminance of the video signal at intervals of a unit time; a conversion coefficient calculation process for calculating a conversion coefficient based on a ratio of each detected peak value to an upper limit of the luminance or based on a difference between each detected peak value and an upper limit of the luminance; a video signal conversion process for performing conversion to increase the luminance value of the video signal in the unit time on the basis of the conversion coefficient and supplying the luminance value to the video display element drive circuit; and a light intensity control process for deciding the light intensity of the light source on the basis of the conversion coefficient, deciding the value of current supplied to the light source by referring to the table on the basis of the decided light intensity and indicating the decided value of current to the light source drive circuit.

(10) The invention provides a projection type video reproducing apparatus including: a video display element for visualizing a video signal; a video display element drive circuit for driving the video display element; a high-speed response light source for applying projection light onto the video display element; a light source drive circuit for turning the light source on and controlling light intensity of the light source by controlling a value of current supplied to the light source; a table storage portion for storing a table indicating the relation between the value of current supplied to the light source and the intensity of light; a light intensity sensor provided near the light source; and a video signal conversion portion which executes: a table generating process for instructing the light source drive circuit to change the current supplied to the light source from a minimum to a maximum, measuring the light intensity of the light source at each value of current by using the light intensity sensor, generating the table on the basis of a result of the measurement and storing the table in the table storage portion; a peak detection process for detecting peak values of luminance of the video signal at intervals of a unit time; a conversion coefficient calculation process for calculating a conversion coefficient based on a ratio of each detected peak value to an upper limit of the luminance or based on a difference between each detected peak value and an upper limit of the luminance; a light intensity control process for deciding the value of current supplied to the light source on the basis of the conversion coefficient and indicating the decided value of current to the light source drive circuit; and a video signal conversion process for converting the luminance value of the video signal in the unit time on the basis of the conversion coefficient, correcting the luminance value by referring to the table and supplying the corrected luminance value to the video display element drive circuit.

(11) In the invention, the table generating process is executed when the projection type video reproducing apparatus is powered on.

(12) In the invention, one device is provided as each of the video display element, the video display element drive circuit, the light source, the light source drive circuit, the table storage portion and the light intensity sensor; and the video signal conversion portion executes the table generating process with respect to the light source and executes the peak detection process, the conversion coefficient calculation process, the video signal conversion process and the light intensity control process successively with respect to the video signal having a plurality of color channels.

(13) In the invention, the video display element, the video display element drive circuit, the light source, the light source drive circuit, the table storage portion and the light intensity sensor are provided in accordance with each color channel; and the video signal conversion portion executes the table generating process with respect to the light source in each color channel and executes the peak detection process, the conversion coefficient calculation process, the video signal conversion process and the light intensity control process with respect to the video signal in a plurality of color channels.

(14) In the invention, one device is provided as each of the light source, the light source drive circuit, the table storage portion and the light intensity sensor; the video display element and the video display element drive circuit are provided in accordance with each color channel; and the video signal conversion portion executes the table generating process with respect to the light source and executes the peak detection process, the conversion coefficient calculation process, the video signal conversion process and the light intensity control process with respect to the video signal having a plurality of color channels.

(Operation)

A subject of the invention as described in the paragraphs (9) to (14) is a projection type video reproducing apparatus in which high-speed response devices such as high-luminance LEDs are used as a light source for applying projection light onto a video display element. In a general projection type video reproducing apparatus (projector), the light source always emits light with predetermined light intensity. In the invention, high-speed response characteristic of the light source is used so that video in a dark scene is converted into bright video while the light source is darkened in accordance with the video conversion. As a result, the same video as in the case of direct reproduction of a dark video signal can be displayed, so that power saving can be attained on the basis of darkening of the light source.

For example, the unit time is a video frame or horizontal scanning period. The highest luminance value in the video signal in this period is set as a peak value. The conversion coefficient is decided so that the peak value is equal to a limit value. The luminance value of the video signal is converted on the basis of the conversion coefficient. The conversion coefficient is the maximum conversion coefficient in the unit time. In this manner, the width of conversion of the video signal can be maximized, so that the light intensity of the light source can be minimized accordingly.

Incidentally, in the case of monochrome video, this process may be performed on the luminance signal once per unit time. In the case of color video, this process is repeated concurrently or successively by the number of colors per unit time. For example, in the case of the three primary colors of R, G and B, this process is executed once each color, that is, this process is executed three times in one unit time. In this case, the luminance value in the invention is a component value of each of R, G and B color component signals.

The light source drive circuit controls the light intensity by controlling the value of current so that the light source emits light with the controlled light intensity constantly in the unit time. When the light intensity of a light source element such as an LED is controlled on the basis of the value of current, displacement occurs because the light output is not direct proportional to the control signal as shown in FIG. 4B. To compensate for the displacement, the value of current supplied to the light source is decided on the basis of the table to thereby keep the linearity.

As described above, according to the invention, when a video signal (dark video) low in luminance value is to be reproduced and displayed, the video which has been heretofore generally darkened to be visualized by the video display element is brightened so that the light intensity of the light source is reduced in accordance with the brightening of the video to reproduce and display the dark video. As a result, the light intensity of the light source can be reduced to the required minimum value, so that electric power consumed by the light source can be suppressed while the life of the light source can be elongated.

In addition, the value of current supplied to the light source is corrected in accordance with the light intensity ratio so that the linearity of the light intensity can be kept.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a configuration diagram of a projection type video reproducing apparatus as an embodiment of the invention;

FIGS. 2A and 2B are views showing other configurations of a display device and a light source in the projection type video reproducing apparatus;

FIG. 3 is a block diagram of a video signal processing portion in the projection type video reproducing apparatus;

FIGS. 4A and 4B are circuit configuration diagrams of a light source driver in the projection type video reproducing apparatus;

FIG. 5 is a view for explaining modes of conversion of a video signal and control of light intensity of the light source in the projection type video reproducing apparatus;

FIG. 6 is a flow chart showing the operation of the video signal processing portion; and

FIG. 7 is a flow chart showing the operation of the video signal processing portion.

### DETAILED DESCRIPTION OF THE PREFERRED EMBODIMENTS

I. Description of Configuration of Apparatus

A projection type video reproducing apparatus (projector) according to an embodiment of the invention will be described with reference to the drawings. The projection type video reproducing apparatus makes a display device such as a digital mirror device display video and makes an LED light source apply light on the video to project the video on a screen.

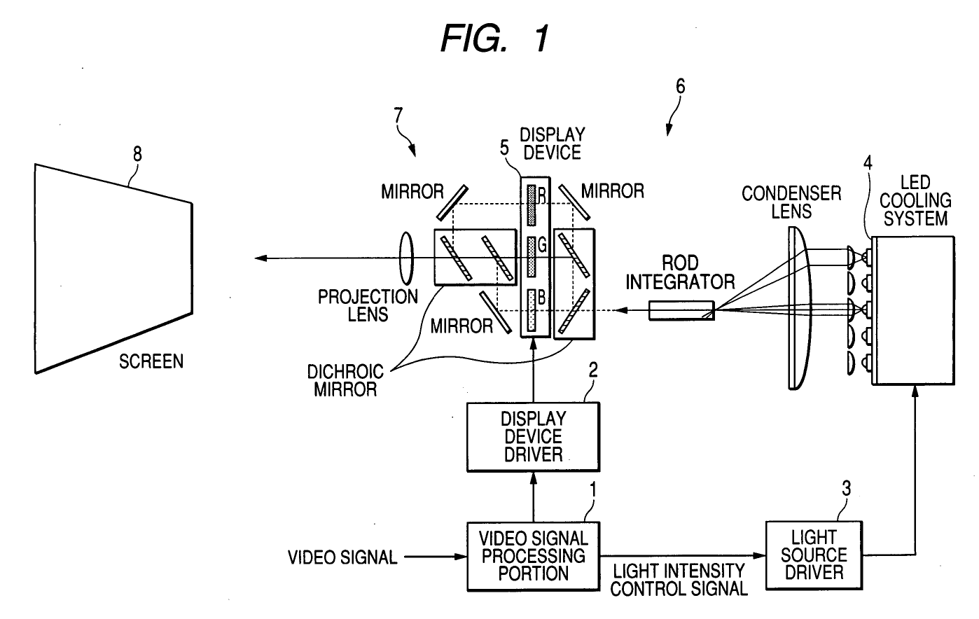

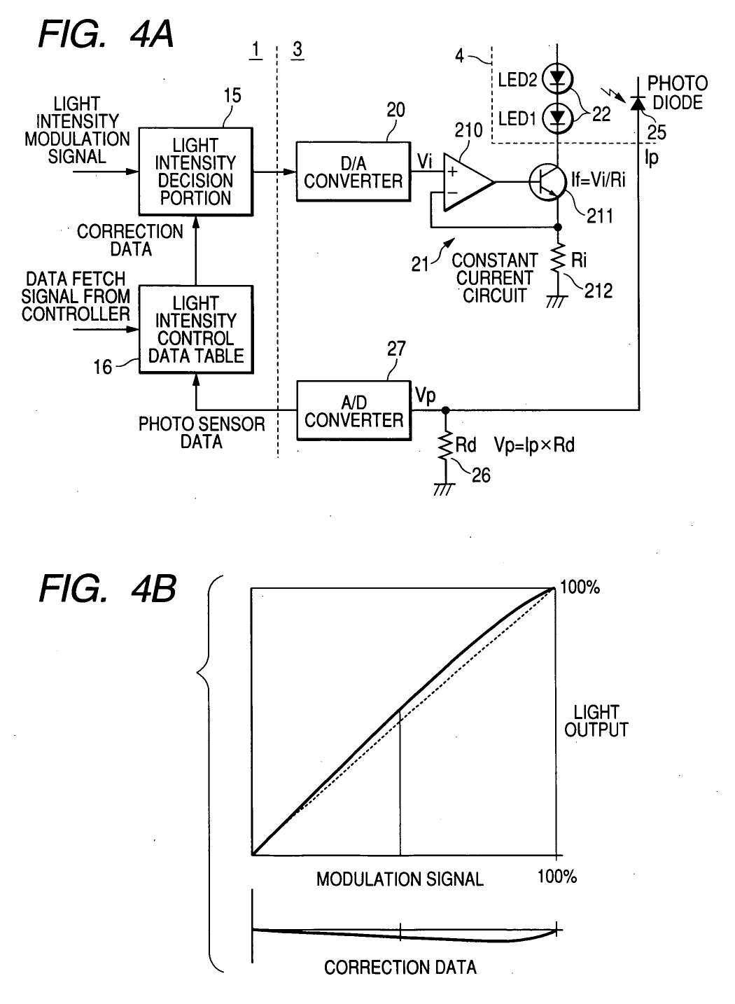

FIG. 1 is a block diagram of the projection type video reproducing apparatus. The projection type video reproducing apparatus includes: a display device 5 for visualizing a video signal; a light source 4 for applying projection light on the display device 5; a light-condensing optical system 6 for leading light of the light source 4 to the display device 5; and a projection optical system 7 by which video displayed on the display device is projected on the screen. The projection type video reproducing apparatus further includes: a display device driver 2 for driving the display device 5; a light source driver 3 for controlling the light source 4; and a video signal processing portion 1 for processing an input video signal and supplying the converted video signal to the display device driver 2 while supplying a light source control signal to the light source driver. Incidentally, the light source 4 has a photodiode 25 as shown in FIG. 4A.

The light-condensing optical system 6 has a condenser lens, a rod integrator, dichroic mirrors, etc. The projection optical system 7 has dichroic mirrors, a projection lens, etc.

In the projection type video reproducing apparatus according to this embodiment, light-emitting elements having high-speed response characteristic are used as the light source 4. Typically, high-luminance LEDs may be used. An example using high-luminance LEDs will be described below.

Although FIG. 1 shows a projector of the type in which a screen 8 is provided opposite to the projector so that video emitted from the projection optical system 7 is projected on the screen 8, the invention can be applied also to a back type video reproducing apparatus which is provided with a housing so that video is projected on a screen provided on a front surface of the housing from a back surface of the inside of the housing.

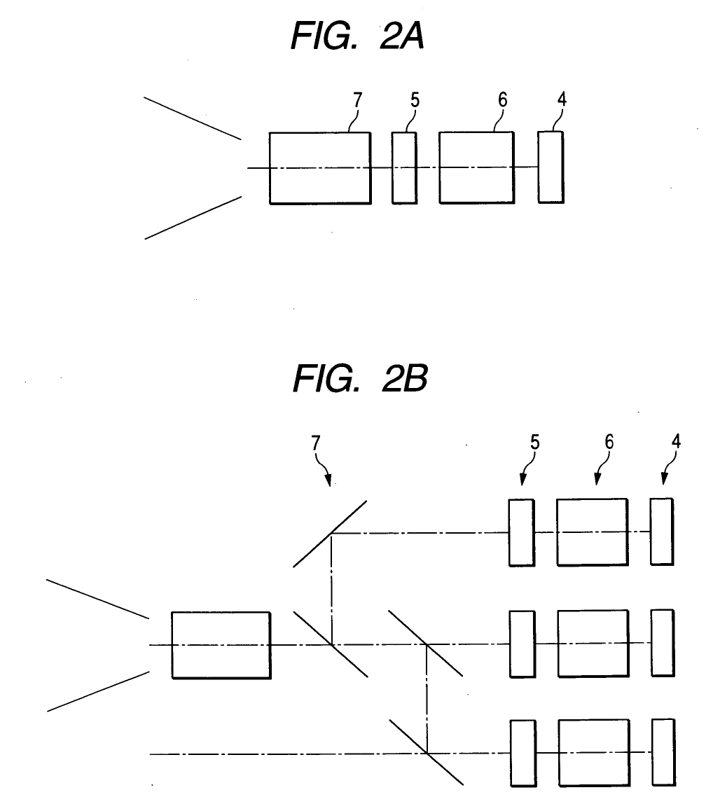

Although FIG. 1 shows a three-device one-light-source configuration in which: three display devices 5 corresponding to the three primary colors of R (red), G (green) and B (blue) are provided; and light emitted from one light source 4 is spectrally separated into light components by dichroic mirrors so that the light components are applied on the display devices 5 respectively, the invention can be applied also to a one-device one-light-source configuration in which one display device 5 is used for reproducing the three primary colors of R, G and B in a time division manner as shown in FIG. 2A and a three-device three-light-source configuration in which three light sources 4 are provided for three display devices 5 respectively as shown in FIG. 2B.

Incidentally, component colors for displaying color video are not limited to the three primary colors of R, G and B. Color video may be displayed with more colors (e.g. six colors). In the following description, the three primary colors of R, G and B will be described representatively.

In the case of a one-device one-light-source configuration in which the three primary colors are displayed in a time division manner, multicolor LEDs are used as a light source 4, so that light is emitted with a color corresponding to a channel (of any one of R, G and B) reproduced by the display device 5. In the case of a three-device one-light-source configuration, white LEDs are used as a light source 4, so that light components of R, G and B are supplied to the display devices 5 by color separation or by filters. In the case of a three-device three-light-source configuration, LEDs emitting light with colors corresponding to respective channels may be used. That is, red LEDs are used for an R channel, green LEDs are used for a G channel and blue LEDs are used for a B channel.

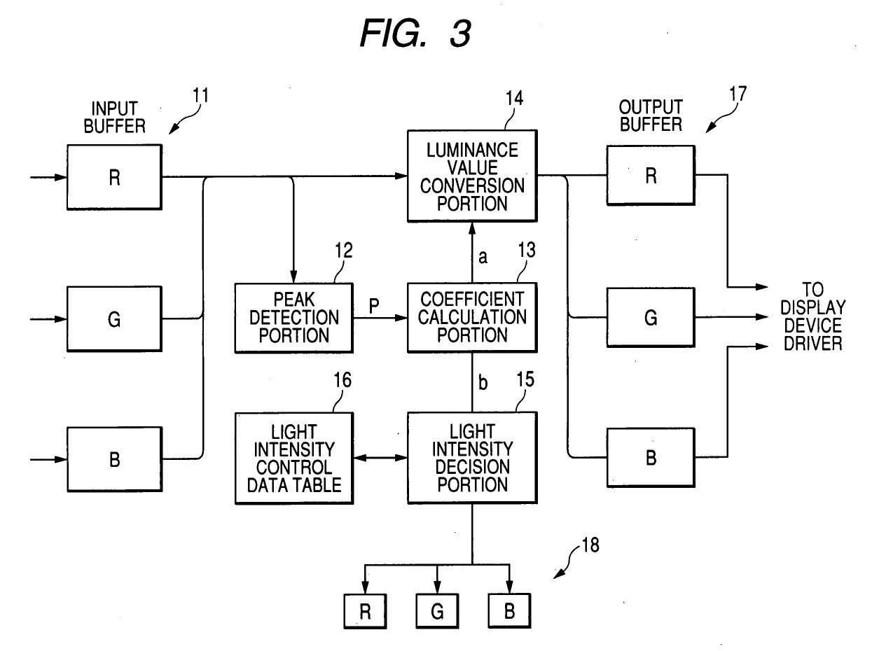

FIG. 3 is a diagram showing the configuration of the video signal processing portion 1. The video signal processing portion 1 has: an input buffer 11 for buffering one frame of the input video signal; a peak detection portion 12 for detecting a maximum luminance value from pixels for the one-frame video data; a coefficient calculation portion 13 for calculating a luminance value conversion coefficient b for converting the video signal into a bright signal and a light intensity control coefficient a for reducing the light intensity of the light source on the basis of the peak detected by the peak detection portion 12; a luminance value conversion portion 14 for converting the luminance value of the video signal stored in the input buffer 11 on the basis of the luminance value conversion coefficient b; an output buffer 17 for buffering the video signal converted by the luminance value conversion portion 14; a light intensity decision portion 15 for deciding light intensity control data on the basis of the light intensity control coefficient a; a light intensity control data table 16 used by the light intensity decision portion 15; and a light intensity control data buffer 18 for buffering the light intensity control data decided by the light intensity decision portion 15.

Incidentally, in FIG. 3, input buffers 11 are provided in parallel, output buffers 17 are provided in parallel and light intensity control data buffers 18 are provided in parallel in accordance with the three primary colors of R, G and B. In this configuration, one video signal processing portion 1 is provided for one or three display devices 5 and one or three light sources 4. In the case where video signal processing portions 1 are provided for R, G and B respectively, each video signal processing portion 1 may be formed so that one input buffer 11, one output buffer 17 and one light intensity control data buffer 18 are provided for a corresponding channel.

Incidentally, selection as to whether one video signal processing portion 1 is provided in common to R, G and B or whether video signal processing portions 1 are provided for R, G and B respectively and selection as to whether one display device 5 and one light source 4 are provided in common to R, G and B or whether display devices 5 and light sources 4 are provided for R, G and B respectively are independent of each other. Any combination may be used.

The input buffer 11 buffers one frame (unit time) of the video signal (digital video signal). The peak detection portion 12 scans pixels (luminance values) of the video signal buffered by the input buffer 11, detects the maximum luminance value in the frame and outputs the detected luminance value as a peak value to the coefficient calculation portion 13.

The coefficient calculation portion 13 calculates a luminance value conversion coefficient b for converting the luminance values (pixel values) of the buffered one-frame pixel data and a light intensity control coefficient a for controlling the light intensity of the LED light source on the basis of the input peak value P. This calculation method will be described later in detail. In short, when the video is dark, the luminance value of the video signal is increased and the light intensity of the light source is reduced in accordance with the increase in luminance value to thereby reduce electric power supplied to the light source.

The luminance value conversion coefficient b calculated by the coefficient calculation portion 13 is inputted to the luminance value conversion portion 14. The luminance value conversion portion 14 fetches the one-frame video signal from the input buffer 11 and multiplies each pixel data by the luminance value conversion coefficient b to thereby change the luminance value of each pixel. As a result, the video signal is converted into a signal brighter than the original video. The converted video signal is written in the output buffer 17.

The video signal written in the output buffer 17 is read by the display device driver 2 at the timing of displaying the next frame and is displayed on the display device 5.

On the other hand, the light intensity control coefficient a calculated by the coefficient calculation portion 13 is inputted to the light intensity decision portion 15. The light intensity decision portion 15 converts the input light intensity control coefficient a into light intensity control data (data indicating the value of the current supplied to the light source 4) by referring to a light intensity control data table 16 shown in FIG. 4B.

The light intensity control data table 16 is a table in which the relation between the value of current supplied to the light source 4 (LEDs) and the light intensity (light output) of the light source 4 (LEDs) is stored. The value of current (the current ratio as against current at full power) to be supplied to the light source 4 can be read when the table 16 is searched on the basis of the light intensity control coefficient a indicating the light intensity ratio as against light intensity at full power.

Incidentally, FIG. 4B shows two kinds of light intensity control data tables. An upper part of FIG. 4B shows a light intensity-current conversion table which indicates the relation between the intensity of light and the value of current and by which the current ratio as against the value of current at full power is deduced from the light intensity ratio (light intensity control coefficient a) as against the intensity of light at full power. A lower part of FIG. 4B shows an error table which indicates error (from direct proportion) of the current ratio corresponding to the light intensity ratio and by which the current ratio can be calculated when the error is multiplied by the light intensity ratio.

The light intensity control data table 16 is generated in such a manner that actual measurement is performed while the current supplied to LEDs of the light source 4 is changed continuously in the condition that a photodiode 25 (see FIG. 4A) as a light intensity detection sensor is provided in the light source 4.

Although the light intensity control data table 16 may be generated at any time, it is more appropriate that the light intensity control data table 16 is generated at the time of powering on the apparatus or in the interval in which inputting of the video signal is stopped.

The operation in the test mode is an operation in which: control is performed so that the current supplied to the LEDs 22 is changed linearly; the light intensity output is actually measured by the photodiode 25 in accordance with each current value; and the measured values of light intensity are tabled. If black is inputted as the video signal, video is never projected onto the screen 8.

Incidentally, because the characteristic of LEDs is relatively uniform, average characteristic data provided from the LED maker may be used directly.

FIG. 4A is a diagram showing the light source driver 3. In the light source driver 3, a D/A converter 20 receives light intensity control data from the light intensity decision portion 15 of the video signal processing portion 1, converts the light intensity control data into an analog current control voltage Vi and inputs the analog current control voltage Vi to a constant current circuit 21. The constant current circuit 21 supplies a current If decided on the basis of the current control voltage Vi to the LED devices 22 mounted in the light source (light source unit) 4 to thereby make the LED devices 22 emit light with predetermined light intensity. Incidentally, the constant current circuit 21 has a comparator 210, a current control transistor 211, and a reference resistor 212 (resistance value Ri). The supply current If is decided by Vi/Ri.

As described above, the photodiode 25 for detecting the intensity of emitted light is provided in the light source unit 4. The intensity of light emitted from the LED devices 22 is detected on the basis of change in resistance value of the photodiode 25. That is, the photodiode 25 has one terminal to which a detection voltage Vdd is applied, and the other terminal grounded through a resistor Rd. A current Ip corresponding to the intensity of light emitted from the LEDs 22 flows in the photodiode 25 and the resistor Rd, so that a detection voltage Vp(=Ip×Rd) is generated between opposite ends of the resistor Rd.

In the test mode for generating the light intensity control data table by actual measurement, an A/D converter 27 converts the voltage Vp into digital data and inputs the digital data to the video signal processing portion 1. The video signal processing portion 1 generates the light intensity control data table having the contents shown in FIG. 4B on the basis of the value of current supplied to the LEDs 22 through the D/A converter 20 and the constant current circuit 21 and the light intensity detection data given from the A/D converter 27.

Although the light source driver 3 is formed to control the current supplied to the light source unit 4 (LEDs 22) to thereby control the light intensity of the light source, the voltage Vi outputted from the D/A converter 20 may be inputted to a PWM signal generating circuit (which is a circuit for inputting the voltage Vi and a saw-tooth voltage to a comparator and generating a pulse in the period that the saw-tooth voltage is not larger than Vi) to thereby perform on-off control of the LEDs on the basis of a PWM signal outputted from the PWM signal generating circuit if the light source needs to be turned on by PWM control so that the light source can be turned on with a pulse width based on the light intensity control data.

In the case of PWM control, it is not necessary to use the photodiode 25 for generating the table or correcting linearity because the pulse width and the light intensity have perfect linear correlation (they are in direct proportion to each other).

Luminance control of the display device 5 is also classified into static control and time division (PWM) control. In the static control, the display device is driven on the basis of predetermined transmittance or reflectance corresponding to luminance. In the time division (PWM) control, the display device is driven on the basis of 100% transmittance or reflectance only in a time width corresponding to luminance. When the display device 5 is driven by time division control, the light source 4 is driven by static control. When the display device 5 is driven by static control, the light source 4 is driven by time division control.

As described above, the light intensity decision portion 15 may be formed so that correction is performed on the basis of the error table (which is a table indicating error from a line in the case where the current value and the light intensity are in direct proportion to each other) shown in the lower part of FIG. 4B and stored instead of the light intensity-current conversion table (which is a table in which the relation of the light intensity (light output) of the light source 4 (LEDs) to the value of current supplied to the light source 4 (LEDs)) shown in the upper part of FIG. 4B.

The error table may be further given to a luminance value conversion portion 14 so that the error component can be reflected on the luminance value of each pixel to thereby compensate the error of light intensity with the luminance value.

That is, the light source 4 is controlled to be turned on and off on the basis of the current directly controlled by the ratio indicated by the light intensity control coefficient a. The error component of light intensity due to this control is calculated on the basis of the error table. The luminance value of the video signal is increased/decreased to compensate for the error component.

Incidentally, the table (the light intensity control data table or the error table) may be generated on the basis of data supplied from the LED maker.

II. Description of Converting Procedure

A procedure for deciding the conversion coefficient on the basis of the luminance value (peak value) of the video signal in the projection type video reproducing apparatus having the aforementioned configuration, converting the luminance value of the video signal and controlling the light intensity of the light source will be described.

(1) First, the luminance value of a pixel having the highest luminance in all pixels in one frame is set as a peak value.

(2) The peak value is divided by the luminance limit value (255 in the case of full color (8-bit quantization in each of R, G and B components)) to thereby calculate luminance ratio A.

(3-1) The luminance ratio A is decided as a light intensity control coefficient a and the reciprocal of the intensity control coefficient a is decided as a luminance value conversion coefficient (1/a=b) and inputted to the luminance value conversion portion 14.

(3-2) If the luminance ratio A is not smaller than a threshold (0.1) (when the light source 4 is controlled by static control in which light intensity is controlled on the basis of the value of current supplied), the luminance value A is decided directly as the light intensity control coefficient a and the reciprocal of the light intensity control coefficient a is decided as the luminance value conversion coefficient (1/a=b) and inputted to the luminance value conversion portion 14.

If the luminance value A is smaller than the threshold, the light intensity control coefficient a is set as the threshold and the reciprocal of the light intensity control coefficient a is set as the luminance value conversion coefficient and inputted to the luminance value conversion portion 14.

This is because the operation of the LEDs 22 becomes unstable in a state in which the current supplied to the LEDs 22 is small (in the region in which the applied voltage is low), so that it is difficult to keep the on state of the LEDs 22 stable. For this reason, the smallest value required for compensating a stable operation is set as a threshold, so that conversion/control is performed with the threshold as a limit even in the case where the luminance ratio A is smaller than the threshold.

(4) If the peak value is zero the luminance value conversion coefficient b is set to 1. When the luminance value conversion coefficient b of 1 is inputted to the luminance value conversion portion 14, the luminance value conversion portion 14 transfers the video signal of the input buffer 11 to the output buffer 17 directly without any processing.

(5) (When the light source 4 is controlled by static control), if the peak value is zero, the light intensity control coefficient a is set as the threshold (0.1) but the value a is reduced gradually from the threshold if the peak value zero is continued. The slope of the reduction is provided so that the light intensity control coefficient a becomes equal to zero (turning off) in about one second. As a result, approximate black condition (total blackness) can be achieved and further power saving can be made.

(6) The light intensity control coefficient a may be decided not only based on the present luminance ratio A but also based on the present luminance ratio A and the past luminance ratio or the past light intensity control coefficient in an averaging manner. When, for example, the light intensity control coefficient a is to be decided on the basis of the present luminance ratio A and the previous luminance ratio Aold in an averaging manner, the present light intensity control coefficient a is calculated in accordance with a=αA+βAold (in which α and β are weighting coefficients). When, for example, the light intensity control coefficient a is to be decided on the basis of the present luminance ratio A and the previous light intensity control coefficient aold in an averaging manner, the present light intensity control coefficient a is calculated in accordance with a=αA+βaold (in which α and β are weighting coefficients).

If the light intensity of the light source and the conversion quantity of the video signal are changed extremely in accordance with each frame, there is a possibility that flickering of video will be caused, for example, by quantization error, displacement of linearity, etc. Therefore, in order to prevent the light intensity control coefficient a and the luminance value conversion coefficient b from changing extremely, the present light intensity control coefficient a and the luminance value conversion coefficient b are calculated on the basis of the present luminance ratio and the past luminance ratio or the past light intensity control coefficient in an averaging manner.

(7) In the aforementioned control, the weighting coefficient a for the present value is increased when video is brightened (i.e. when the present luminance ratio A (or the present peak value P) is not smaller than the previous luminance ratio Aold (or the previous peak value Pold)), and the weighting coefficient α for the present value is set to be substantially equal to the weighting coefficient β for the previous value when video is darkened (i.e. when the present luminance ratio A (or the present peak value P) is smaller than the previous luminance ratio Aold (or the previous peak value Pold)).

This is based on the consideration of the fact that large change of situation such as shift of scene after fade-out occurs frequently or a video effect of changing the dark situation to the bright situation rapidly to call attention is present when the screen is brightened. For this reason, the weighting coefficient for the present value is increased to properly follow the change when video is brightened.

In the aforementioned process, the steps (1), (2) and (3-1) are essential but the steps (3-2) to (7) are optional. The steps selected from these steps may be combined suitably. Any case is within the technical scope of the invention.

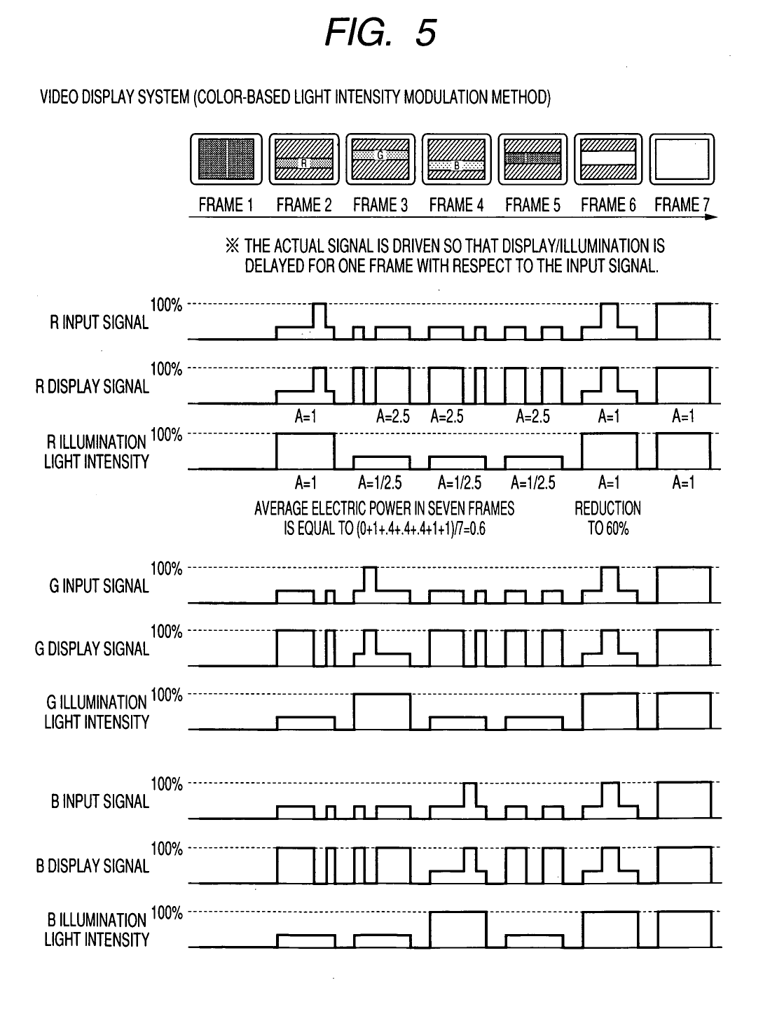

FIG. 5 is a view showing various videos and an example of conversion of the video signal and control of light intensity in accordance with each video. Seven videos (frames 1 to 7) are illustrated in FIG. 5.

The frames 1 to 7 are as follows.

Frame 1: solid black video (peak value zero)

Frame 2: video of a red (R) belt against a gray background

Frame 3: video of a green (G) belt against a gray background

Frame 4: video of a blue (B) belt against a gray background

Frame 5: video of a black belt against a gray background

Frame 6: video of a white belt against a gray background

Frame 7: solid white video

In FIG. 5, the aforementioned process is performed in accordance with each color component (R, G or B). In each color component, video is converted into a display signal so that the peak of the input video signal (input signal) is set to be equal to the luminance limit value (e.g. 255). The display signal is outputted to the display device driver 2.

For example, the peak value of the video signal in the frame 2 is 100% because the R channel has a portion (red belt portion) of 100% luminance. Accordingly, there is no room for converting the video signal largely, so that the luminance value conversion coefficient b and the light intensity control coefficient a are kept equal to 1. On the other hand, the G channel has a gray area of 40% luminance, and an area of 0% luminance in which green is not displayed. Therefore, while the luminance value conversion coefficient is set at 2.5, the luminance is converted to set the light intensity control coefficient a at 0.4. In this manner, in this channel of this frame, 60% light intensity can be saved. Also in the B channel of this frame, 60% light intensity can be saved.

This thing can be applied to the other frames. In total, 40% light intensity (electric power) can be saved. Incidentally, when this process is applied to monochrome (gray-scale) video, it is a process for the luminance value Y in one channel.

Incidentally, in the conversion step (1), one-frame data stored in the input buffer 11 may be scanned to detect the peak value of luminance. The input video signal may be checked in real time to hold the peak value so that the held peak value can be used when a one-frame video signal is inputted.

III. Description of Operation of Video Signal Processing Portion

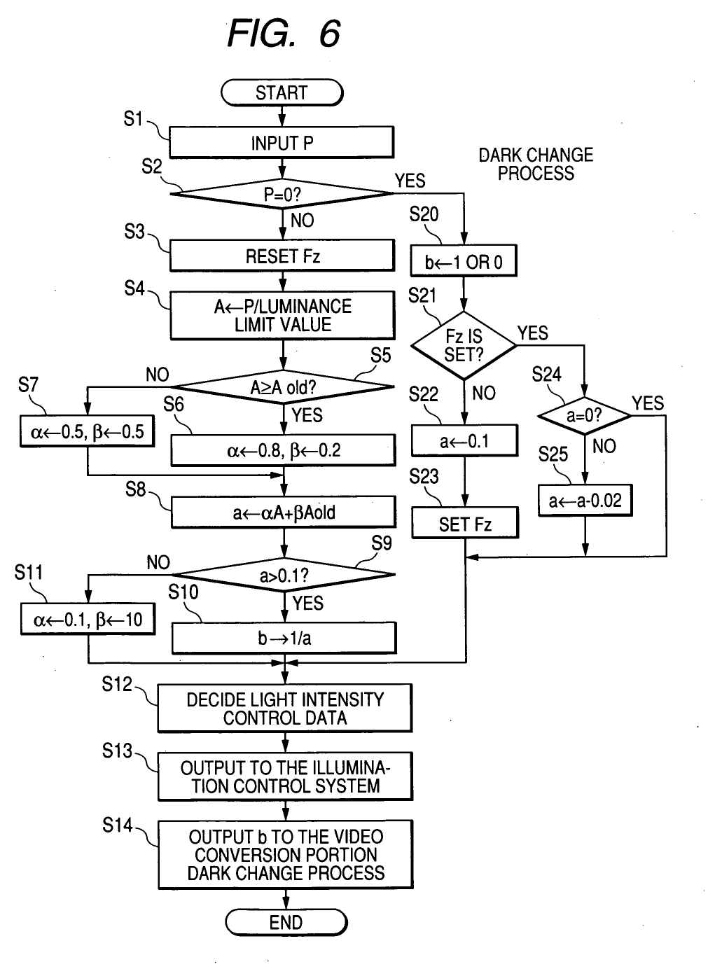

The coefficient calculation process will be described with reference to FIG. 6. First, a luminance peak value P is inputted from the peak detection portion 12 (s1). When the peak value P is zero, the screen (this color component) is judged to be dark-changed so that the situation of this routine goes to a dark change process (steps s20 to s25).

When the peak value P is not zero (larger than zero), a dark change flag Fz indicating that the peak value is zero is reset (s3) and the peak value P is divided by a luminance limit value (255 in the case of 8 bits) to calculate the luminance ratio A (s4). The luminance ratio A is a value indicating the ratio of the peak value in this frame (this color component) to the luminance limit value.

The luminance value conversion coefficient b and the light intensity control coefficient a are calculated on the basis of the present luminance ratio A and the previous luminance ratio Aold (of the same color component in the preceding frame) in a weighted averaging manner. When the present luminance is higher than the previous luminance, weighting for the present value is increased. When the present luminance is lower than the previous luminance, weighting for the present value is set at the same ratio as weighting for the previous value.

A judgment is made as to whether the present luminance ratio A is not smaller than the previous luminance ratio Aold (of the same color component in the preceding frame) (s5).

When the present luminance ratio A is not smaller than the previous luminance ratio Aold, the weighting coefficient α for the present luminance ratio A is set at 0.8 while the weighting coefficient β for the previous luminance ratio Aold is set at 0.2 (s6). On the other hand, when the present luminance ratio A is smaller than the previous luminance ratio Aold, both the weighting coefficient α for the present luminance ratio A and the weighting coefficient β for the previous luminance ratio Aold are set at 0.5 (s7). Then, the light intensity control coefficient a is calculated by the arithmetic operation α×A+β×Aold (s8).

Although this example has shown the case where the light intensity control coefficient a is calculated by taking a weighted average of the present luminance ratio A and the previous luminance ratio Aold, the light intensity control coefficient a may be calculated by taking a weighted average of the present luminance ratio A and the previous light intensity control coefficient aold.

Next, it is judged whether the light intensity control coefficient a calculated this is larger than 0.1 or not (s9). When the light intensity control coefficient a is larger than 0.1, the light source 4 is still in a range to operate normally even by static control based on this coefficient so that the light intensity control coefficient a is used directly and the reciprocal of the light intensity control coefficient a is decided as the luminance value conversion coefficient b (s10).

On the other hand, when the light intensity control coefficient a calculated by the operation of s8 is smaller than 0.1, there is a possibility that the light source 4 (LEDs) cannot operate normally so that the light intensity control coefficient a is rewritten to 0.1 in the minimum control range for warranting a normal operation and the luminance value conversion coefficient b is set at 10 correspondingly to 0.1 (s11).

The light intensity control data is deduced on the basis of the decided light intensity control coefficient a (s12). While the light intensity control data is outputted to the light source driver 3 (s13), the luminance value conversion coefficient b is inputted to the luminance value conversion portion 14 (s14).

Next, the dark change process of steps s20 to s25 will be described. When a decision is made in s2 that the peak value is zero, the luminance value conversion coefficient b is first set at 1 (s20). When the luminance value conversion coefficient b is 1, the luminance value conversion portion 14 skips the luminance value conversion process and transfers the video signal inputted from the input buffer 11 directly to the output buffer 17.

Then, a judgment is made as to whether the dark change flag Fz is set or not (s21). The fact that the dark change flag Fz is set means the fact that the peak value zero is continued from the preceding frame.

When Fz is not set (the dark change is to start), the light intensity control coefficient a is set at 0.1 (s22), the flag Fz is set (s23) and the situation of this routine goes to s12. When Fz has been already set, 0.02 is subtracted from a to reduce the light intensity gradually (s25). When a has been already zero, this process is skipped (s24). After this process, the situation of this routine goes to s12. By subtracting 0.02 from a, the light intensity reaches zero when the peak value zero is continued for 50 frames (about 1.7 sec).

This process aims at suppressing light emission to achieve the approximate black condition (total blackness) and save electric power when the peak value zero is long. In addition, when the luminance ratio A becomes larger than the luminance ratio Aold in the preceding frame, the luminance ratio A can follow the change rapidly. Accordingly, even in the case where the light source is turned off in the peak value zero, there is no barrier to video reproduction after that.

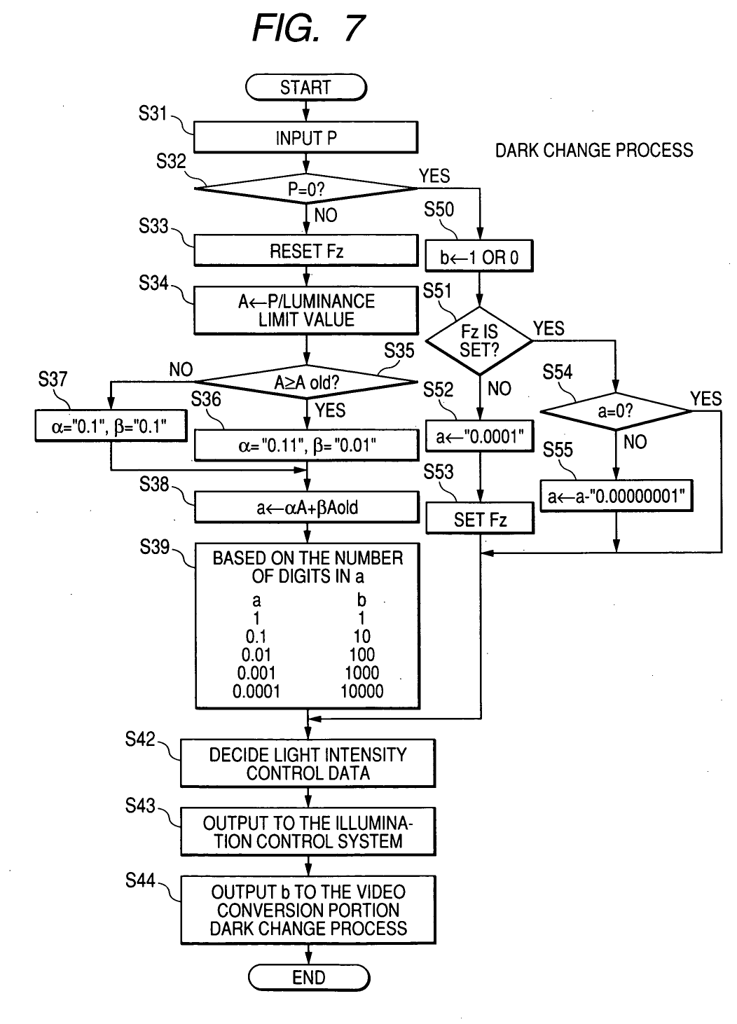

FIG. 7 shows another example of the coefficient calculation operation of the video signal processing portion. In this operation, all coefficients are processed in the form of binary numbers. This is an operation for deciding the luminance value conversion coefficient b as a binary number having bits “0” except the most significant bit “1”. As a result, the operation of the luminance value conversion portion 14 can be achieved by only bit shift, so that the quantity of arithmetic operation can be lightened extremely.

This flow chart will be described below.

In FIG. 7, first, the peak value P of luminance is inputted from the peak detection portion 12 (s31). When the peak value P is zero, the screen (this color component) is judged to be dark-changed so that the situation of this routine goes to a dark change process (steps s50 to s55).

When the peak value P is not zero (larger than zero), a dark change flag Fz indicating that the peak value is zero is reset (s33) and the peak value P is divided by a luminance limit value (“11111111” (255) in the case of 8 bits) to calculate the luminance ratio A (s34).

A judgment is made as to whether the present luminance ratio A is not smaller than the previous luminance ratio Aold (s35). When the present luminance ratio A is not smaller than the previous luminance ratio Aold, the weighting coefficient α for the present luminance ratio A is set at “0.11” (0.75) while the weighting coefficient β for the previous luminance ratio Aold is set at “0.01” (0.25) (s36). On the other hand, when the present luminance ratio A is smaller than the previous luminance ratio Aold, both the weighting coefficient α for the present luminance ratio A and the weighting coefficient β for the previous luminance ratio Aold are set at “0.1” (0.5) (s37). Then, the light intensity control coefficient a is calculated by the arithmetic operation α×A+β×Aold (s38).

Although this example has shown the case where the light intensity control coefficient a is calculated by taking a weighted average of the present luminance ratio A and the previous luminance ratio Aold, the light intensity control coefficient a may be calculated by taking a weighted average of the present luminance ratio A and the previous light intensity control coefficient aold.

Then, the light intensity control coefficient a and the luminance value conversion coefficient b to be used for actual processing are decided on the basis of the number of digits in the calculated light intensity control coefficient a (s39). This decision is made as “a binary fraction (e.g. “0.001”) having digits “0” expect the least significant digit of decimal place “1” after the binary point” which is not smaller than the calculated light intensity control coefficient a and is closest to the calculated light intensity control coefficient a. As a result, only bit shift can be used for conversion of the luminance value of each pixel in the luminance value conversion portion 14. The reciprocal (e.g. “1000”) of the binary fraction is set as the luminance value conversion coefficient b. No matter how small the calculated light intensity control efficient a is, the light intensity control coefficient a is limited to “0.0001” so that a value smaller than “0.0001” is not set as the light intensity control coefficient a. In this manner, the threshold limiting process is performed.

The light intensity control data is deduced on the basis of the decided light intensity control coefficient a (s42). While the light intensity control data is outputted to the light source driver 3 (s43), the luminance value conversion coefficient b is inputted to the luminance value conversion portion 14 (s44).

Next, the dark change process of steps s50 to s55 will be described. When a decision is made in s32 that the peak value is zero, the luminance value conversion coefficient b is first set at 1 (s50). When the luminance value conversion coefficient b is 1, the luminance value conversion portion 14 skips the luminance value conversion process and transfers the video signal inputted from the input buffer 11 directly to the output buffer 17.

Then, a judgment is made as to whether the dark change flag Fz is set or not (s51). When Fz is not set, the light intensity control coefficient a is set at “0.0001” (0.0625= 1/16) (s52), the flag Fz is set (s53) and the situation of this routine goes to s42. When Fz has been already set, “0.00000001” ( 1/256) is subtracted from a to reduce the light intensity gradually (s55). When a has been already zero, this process is skipped (s54). After this process, the situation of this routine goes to s42. By subtracting “0.00000001” from a, the light intensity reaches zero when the peak value zero is continued for 16 frames (about 0.5 sec).

Although the embodiment has been described about control in the case of a three-device one-light-source system, this control may be applied to a one-device one-light-source system or a multiple-device multiple-light-source system (such as a three-device three-light-source system) as follows.

In the case of a one-device one-light-source system, a plurality of colors (e.g. three colors) are displayed in a time division manner. The maximum value of luminance in each color is calculated in accordance with the time division slot of the color so that the luminance value is converted and the light intensity is converted. At the time of conversion, error between the light intensity ratio (light intensity control coefficient a) and the current ratio is corrected on the basis of the light intensity control data table.

In the case of a multiple-device multiple-light-source system, the maximum value of luminance is calculated independently in accordance with each color so that the luminance value is converted and the light intensity is converted. At the time of conversion, error between the light intensity ratio (light intensity control coefficient a) and the current ratio is corrected on the basis of the light intensity control data table. Incidentally, in the case of this system, the light intensity control data table is generated by execution of a test mode operation in accordance with each color because the light sources are independent in accordance with colors.

Although the invention has been illustrated and described for the particular preferred embodiments, it is apparent to a person skilled in the art that various changes and modifications can be made on the basis of the teachings of the invention. It is apparent that such changes and modifications are within the spirit, scope, and intention of the invention as defined by the appended claims.

The present application is based on Japan Patent Application No. 2005-054635 filed on Feb. 28, 2005 and Japan Patent Application No. 2005-186373 filed on Jun. 27, 2005, the contents of which are incorporated herein for reference.

What is claimed is:

1. A projection type video reproducing apparatus, comprising:
a video display element that visualizes a video signal;
a video display element drive circuit that drives the video display element;
a high-speed response light source that applies projection light onto the video display element;
a light source drive circuit that turns the light source on; and
a video signal conversion portion that executes:
a peak detection process for detecting peak values of luminance of the video signal at intervals of a unit time;
a conversion coefficient calculation process for calculating a conversion coefficient based on a ratio of each detected peak value to an upper limit of the luminance or based on a difference between each detected peak value and an upper limit of the luminance;
a video signal conversion process for converting the luminance value of the video signal in the unit time based on the conversion coefficient so as to increase the luminance value and supplying the luminance value to the video display element drive circuit; and
a light intensity control process for setting a control value based on the conversion coefficient to reduce the light intensity of the light source and controlling the light source drive circuit in accordance with the control value.

2. The projection type video reproducing apparatus according to claim 1, wherein when the conversion coefficient calculated by the conversion coefficient calculation process is smaller than a predetermined threshold, the video signal conversion portion sets the threshold as the conversion coefficient instead and executes the video signal conversion process and the light intensity control process.

3. The projection type video reproducing apparatus according to claim 1, wherein in the conversion coefficient calculation process, the conversion coefficient is calculated based on ratios or differences calculated when the conversion coefficient calculation process is executed for a present unit time and at least one past unit time.

4. The projection type video reproducing apparatus according to claim 3, wherein in the conversion coefficient calculation process, the conversion coefficient is calculated by taking a weighted average of ratios or differences calculated when the conversion coefficient calculation process is executed for a present unit time and at least one past unit time; and
wherein weighting for the ratio of the present unit time in the weighted average is increased when the ratio of the present unit time is greater than the ratio of the preceding unit time or weighting for the difference of the present unit time in the weighted average is increased when the difference of the present unit time is smaller than the difference of the preceding unit time.

5. The projection type video reproducing apparatus according to claim 1, wherein the video signal conversion portion executes the respective processes digitally so that only the most significant bit of the conversion coefficient is calculated as a binary digit “1” in the conversion coefficient calculation process and the luminance value of each pixel of the video signal is bit-shifted by the number of digits “0” in the conversion coefficient so as to be increased in the video signal conversion process.

6. The projection type video reproducing apparatus according to claim 1, wherein the video display element drive circuit visualizes the video signal by driving the video display element at a time rate corresponding to the luminance value of the video signal; and
wherein the light source drive circuit controls the light intensity of the light source by controlling the value of current supplied to the light source.

7. The projection type video reproducing apparatus according to claim 1, wherein the video display element drive circuit visualizes the video signal by driving the video display element to obtain transmittance or reflectance corresponding to the luminance value of the video signal; and
wherein the light source drive circuit controls the light intensity of the light source by controlling a time rate at which a current is supplied to the light source.

8. The projection type video reproducing apparatus according to claim 6, wherein the video signal conversion portion stores relation data indicating the relation between the value of current supplied to the light source and the intensity of light; and
wherein in the light intensity control process, the light intensity of the light source is decided on the basis of the conversion coefficient, the value of current is decided by searching the relation data on the basis of the decided light intensity, and the decided value of current is indicated to the light source drive circuit.

9. A projection type video reproducing apparatus, comprising:
a video display element that visualizes a video signal;
a video display element drive circuit that drives the video display element;
a high-speed response light source that applies projection light onto the video display element;
a light source drive circuit that turns the light source on and controls light intensity of the light source by controlling a value of current supplied to the light source;
a storage portion that storing relation data indicating the relation between the value of current supplied to the light source and the intensity of light;
a light intensity sensor provided near the light source; and
a video signal conversion portion that executes:
a data generating process for instructing the light source drive circuit to change the current supplied to the light source from a minimum to a maximum, measuring the light intensity of the light source at each value of current by using the light intensity sensor, generating the relation data on the basis of a result of the measurement and storing the relation data in the storage portion;
a peak detection process for detecting peak values of luminance of the video signal at intervals of a unit time;
a conversion coefficient calculation process for calculating a conversion coefficient based on a ratio of each detected peak value to an upper limit of the luminance or based on a difference between each detected peak value and an upper limit of the luminance;
a video signal conversion process for performing conversion to increase the luminance value of the video signal in the unit time on the basis of the conversion coefficient and supplying the luminance value to the video display element drive circuit; and
a light intensity control process for deciding the light intensity of the light source on the basis of the conversion coefficient, deciding the value of current supplied to the light source by referring to the relation data on the basis of the decided light intensity and indicating the decided value of current to the light source drive circuit.

10. A projection type video reproducing apparatus, comprising:
a video display element that visualizes a video signal;
a video display element drive circuit that drives the video display element;
a high-speed response light source that applies projection light onto the video display element;
a light source drive circuit that turns the light source on and controls light intensity of the light source by controlling a value of current supplied to the light source;
a storage portion that stores relation data indicating the relation between the value of current supplied to the light source and the intensity of light;
a light intensity sensor provided near the light source; and
a video signal conversion portion that executes:
a data generating process for instructing the light source drive circuit to change the current supplied to the light source from a minimum to a maximum, measuring the light intensity of the light source at each value of current by using the light intensity sensor, generating the relation data on the basis of a result of the measurement and storing the relation data in the storage portion;
a peak detection process for detecting peak values of luminance of the video signal at intervals of a unit time;
a conversion coefficient calculation process for calculating a conversion coefficient based on a ratio of each detected peak value to an upper limit of the luminance or based on a difference between each detected peak value and an upper limit of the luminance;
a light intensity control process for deciding the value of current supplied to the light source on the basis of the conversion coefficient and indicating the decided value of current to the light source drive circuit; and
a video signal conversion process for converting the luminance value of the video signal in the unit time on the basis of the conversion coefficient, correcting the luminance value by referring to the relation data and supplying the corrected luminance value to the video display element drive circuit.

11. The projection type video reproducing apparatus according to claim 9, wherein the data generating process is executed when the projection type video reproducing apparatus is powered on.

12. The projection type video reproducing apparatus according to claim 9, wherein one device is provided as each of the video display element, the video display element drive circuit, the light source, the light source drive circuit, the storage portion and the light intensity sensor; and
wherein the video signal conversion portion executes the data generating process with respect to the light source and executes the peak detection process, the conversion coefficient calculation process, the video signal conversion process and the light intensity control process successively with respect to the video signal having a plurality of color channels.

13. The projection type video reproducing apparatus according to claim 9, wherein the video display element, the video display element drive circuit, the light source, the light source drive circuit, the storage portion and the light intensity sensor are provided in accordance with each color channel; and
wherein the video signal conversion portion executes the data generating process with respect to the light source in each color channel and executes the peak detection process, the conversion coefficient calculation process, the video signal conversion process and the light intensity control process with respect to the video signal in a plurality of color channels.

14. The projection type video reproducing apparatus according to claim 9, wherein one device is provided as each of the light source, the light source drive circuit, the storage portion and the light intensity sensor;
wherein the video display element and the video display element drive circuit are provided in accordance with each color channel; and
wherein the video signal conversion portion executes the data generating process with respect to the light source and executes the peak detection process, the conversion coefficient calculation process, the video signal conversion process and the light intensity control process with respect to the video signal having a plurality of color channels.

15. The projection type video reproducing apparatus according to claim 10, wherein the data generating process is executed when the projection type video reproducing apparatus is powered on.

16. The projection type video reproducing apparatus according to claim 10, wherein one device is provided as each of the video display element, the video display element drive circuit, the light source, the light source drive circuit, the storage portion and the light intensity sensor; and
wherein the video signal conversion portion executes the data generating process with respect to the light source and executes the peak detection process, the conversion coefficient calculation process, the video signal conversion process and the light intensity control process successively with respect to the video signal having a plurality of color channels.

17. The projection type video reproducing apparatus according to claim 10, wherein the video display element, the video display element drive circuit, the light source, the light source drive circuit, the storage portion and the light intensity sensor are provided in accordance with each color channel; and
wherein the video signal conversion portion executes the data generating process with respect to the light source in each color channel and executes the peak detection process, the conversion coefficient calculation process, the video signal conversion process and the light intensity control process with respect to the video signal in a plurality of color channels.

18. The projection type video reproducing apparatus according to claim 10, wherein one device is provided as each of the light source, the light source drive circuit, the storage portion and the light intensity sensor;
wherein the video display element and the video display element drive circuit are provided in accordance with each color channel; and
wherein the video signal conversion portion executes the data generating process with respect to the light source and executes the peak detection process, the conversion coefficient calculation process, the video signal conversion process and the light intensity control process with respect to the video signal having a plurality of color channels.
